(19) United States
(12) Patent Application Publication
(10) Pub. No.: US 2007/0159297 A1
(43) Pub. Date: Jul. 12, 2007

(54) Secure Key Lock Box System

(76) Inventors: Howard Lott Paulk, Cumming, GA (US); Donald Franklin Pruitt, Dahlonega, GA (US)

Correspondence Address: BRIAN D. BELLAMY, P.O. BOX 1997, THOMASVILLE, GA, 31799-1997, US

(21) Appl. No.: 11/615,962

(22) Filed: Dec. 23, 2006

Related U.S. Application Data
(60) Provisional application No. 60/754,045, filed on Dec. 27, 2005.

(51) Int. Cl. B60R 25/00

(52) U.S. Cl. 340/5.73; 340/5.62; 340/5.33

(57) ABSTRACT

A secure lock box system for secure storage and retrieval of a stored key includes a key fob device that requests access to a lock box by inductive or optical communication. The individual key fob is authorized for access to the lock box by prior radio communication with a key fob controller that validates the key fob. A lock box controller in combination with applied pressure to a latch hook conserves power and controls access to the key by operation of a low power solenoid and a latch mechanism. Tampering with the lock box is detected by a piezo film motion sensor that provides a signal to a microprocessor, which is awakened from a low power condition by the signal. Upon access grant or an unauthorized attempt at access to the lock box, a message is transmitted from the lock box to an annunciator. The annunciator relays a message concerning the attempted access to a server where a log is created and stored. The server and key fob controller maintain data concerning one or more key fob devices and provide separate authentication data for each. The annunciator warns of any unauthorized access attempt or tampering with the lock box.

### PRIORITY CLAIM

The present application claims benefit of U.S. provisional patent application No. 60/754,045 filed on Dec. 27, 2005.

### BACKGROUND OF THE INVENTION

1. Field of the Invention

The present invention relates to apparatus and methods for securing a key for a vehicle or other structure near its lock. More particularly, the invention relates to an electronically operated secure lock box system for storing a key released only by secure operation.

2. Description of the Prior Art

Persons responsible for a high volume key-locked property have a problem keeping up with the keys to those items and supplying them for the respective items when needed. For instance, automobile dealerships need to provide keys to vehicles when needed. There are advantages in time and convenience to having the keys at the vehicle. These advantages have been shown to result in more sales at automobile dealerships if the keys to a vehicle can be kept near the vehicle. Unfortunately, leaving the keys of a vehicle in the unsecured location of the vehicle can result in a loss of security.

### BRIEF SUMMARY OF THE INVENTION

The invention provides a method of securing the key for a vehicle on the vehicle, or for securing any key on any structure near the lock. It provides an enclosure for the key that is waterproof and will operate year round regardless of temperature. It provides a method of opening the lock box with an access device that does not require a hole to be cut in the lock box enclosure. It provides a lock box with a latch mechanism that will not open when the box is banged or dropped. The invention provides a means of inexpensively remotely deactivating the lock box access mechanism. The invention provides a cost effective and low power method of detecting tampering of the lock box. The invention provides a method of radio frequency communication which avoids FCC approval issues, saves power, and lowers the risk of radio interference from other systems.

One advantage of this invention is the use of an inductive communication link between the key fob and the lock box. This method eliminates the need for holes in the lock box cover where water might otherwise enter the lock box and destroy the electronics.

Another advantage of the inductive communication link is that the power to operate the link is provided by an outside source therefore not drawing current from the internal lock box battery.

Another advantage of the inductive key fob is that it is microprocessor based and can be easily electronically reprogrammed, de-activated or re-keyed thereby eliminating the costly physical re-keying of lock boxes required by traditional currently available key lock systems.

Another advantaged of this invention is that authorization to access the lock box is granted from the server where by simply changing a database, the key fob access can be changed, controlled by a calendar schedule, turned off, and restricted as to which key lock boxes can be accessed.

Another advantage of this invention is the simplified design of the latch mechanism, thereby reducing parts count, making the lock box easier to manufacture, more reliable, easier to maintain, and significantly lower cost. Further, the mechanism solves a previous problem of the latch opening when tampered by banging or dropping the box.

Another advantage of this invention is significantly improved solenoid control, providing lower power consumption, operation on lower battery voltage, extending battery life and significantly simplifying the operation of the lock box.

Another advantage of this invention is the use of a frequency shift keyed modulation radio with multiple channels in both forward and reverse direction to act as a relay for communication between lock box and sound and strobe light alarm unit hereafter referred to as an annunciator. This radio is less complicated and less expensive than a spread spectrum radio. Multiple frequency channels allow for multiple adjacent facilities without congestion and interference. Larger facilities can employ different frequencies in different zones to avoid radio frequency congestion and improve bandwidth.

Another advantage of this invention is the application of a passive piezo film motion sensor for detecting tampering. This sensor is very low power, extending battery life. Further this motion sensor, is much less expensive than previous technologies.

Another advantage of this invention is that the lock box does not need to be polled. This avoids the periodic radio transmissions not allowed by the FCC and greatly simplifies getting FCC approvals.

### BRIEF DESCRIPTION OF DRAWINGS

FIG. 1 shows a schematic of a vehicle lock box system according to the present invention.

FIG. 2 is a perspective view of the internal features of a key lock box constructed in accordance with an embodiment of the present invention.

FIG. 3 is a perspective view of the internal features of a key lock box constructed in accordance with an alternative embodiment of the present invention.

FIG. 4 is a front elevation view of an internal latch and latch hook interlock mechanism in accordance with one embodiment the invention.

FIG. 5 is a front elevation view of a latch mechanism during a process of the invention referred to as drawer push.

FIG. 6 is a front elevation view of a latch in accordance with the invention rotated out of position during a process of the invention referred to as drawer open.

FIG. 7 is a circuit layout for a key lock box controller in accordance with the present invention.

FIG. 8 is a circuit layout for a key fob in accordance with the present invention.

FIG. 9 is a circuit layout for a key fob reader/writer in accordance with the present invention.

FIG. 10 is a block diagram of the sound and strobe light alarm unit, referred to herein as an annunciator, which in constructed in accordance with an embodiment of the present invention.

### DETAILED DESCRIPTION OF THE DRAWINGS

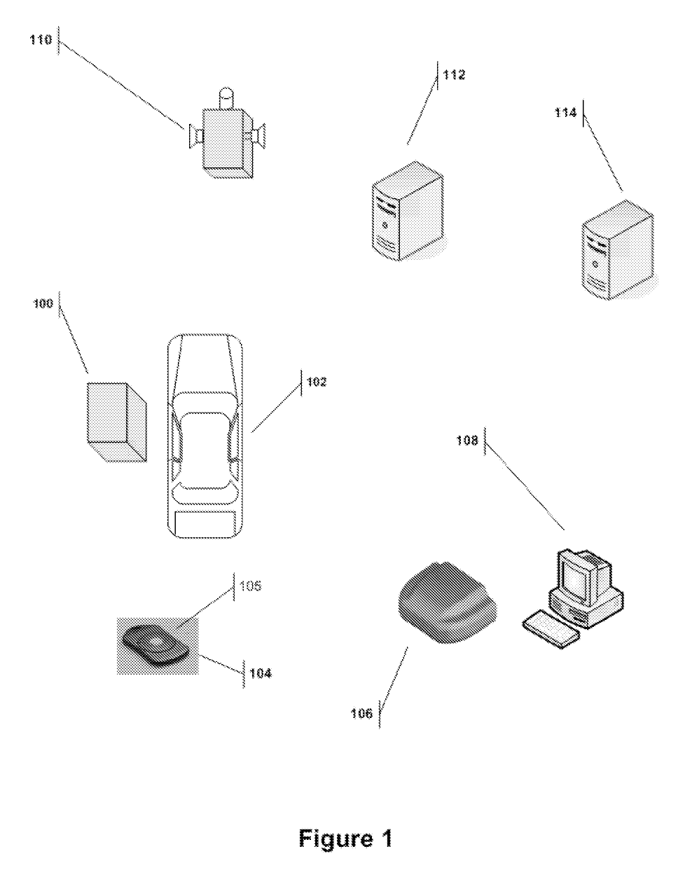

FIG. 1 provides a overall system perspective of the vehicle lock box system invention. Vehicle 102 has on it placed a lock box 100 which contains the key 122 for the vehicle. When a person wishes to gain access to the vehicle key 122, that person must place key fob 104 adjacent to lock box 100 and press key fob button 105 thereby requesting access to the lock box.

Before the key lock box 100 will allow a key fob 104 access, the key fob must be placed adjacent to key fob reader 106. When key fob button 105 is pressed with key fob 104 adjacent to key fob reader 106, a message is transmitted to a key fob reader controller 108 requesting authorization to gain access to lock box 100. Key fob reader controller 108 acts as a registration controller for a multiple key fob devices. The key fob controller verifies that each key fob 104 is valid by looking up said fob in a server database 112. Various key fob may be provided different and multiple authorizations, which may be sent to the lock box. These authorizations provided to both the lock box and the key device may provide different levels of access. For instance, a master level access may be programmed to always work, and a daily level access may be programmed to work on a schedule. Other possible levels of access include porter, general manager, fireman, policeman, owner, salesman, etc. Any key device can be turned off via a message to the lock box from the server.

When access to key lock box 100 is granted, a radio frequency message is transmitted from key lock box 100 to sound and strobe light unit 110 (hereafter referred to as annunciator 110). The Annunciator functions as a relay unit for communication between the lock box controller and registration controller, and, in turn, the annunciator relays the message to server 112 where the access is logged for later retrieval and report generation.

If an unauthorized fob attempts to gain access to lock box 100, a message is transmitted from lock box 100 to annunciator 110 indicating such attempt. Annunciator 110 turns on the strobe light 218 and plays messages via speakers 214a and 214b in an attempt to warn off such unauthorized access attempts. Further, any motion detected by lock box 110 motion sensor 190 may be programmed to be interpreted as an unauthorized access attempt and cause Annunciator to also turn on strobe light 218 and play messages via speakers 214a and 214b. Further all such unauthorized access attempts are relayed by sound and strobe light unit 110 to server 112 where such attempts are logged to a database. Server 112 may be programmed to further call a alarm monitoring system or police station.

Database located in onsite server 112 may be synchronized with database located in offsite server 114 to allow the data of many facilities to be centrally collected and located.

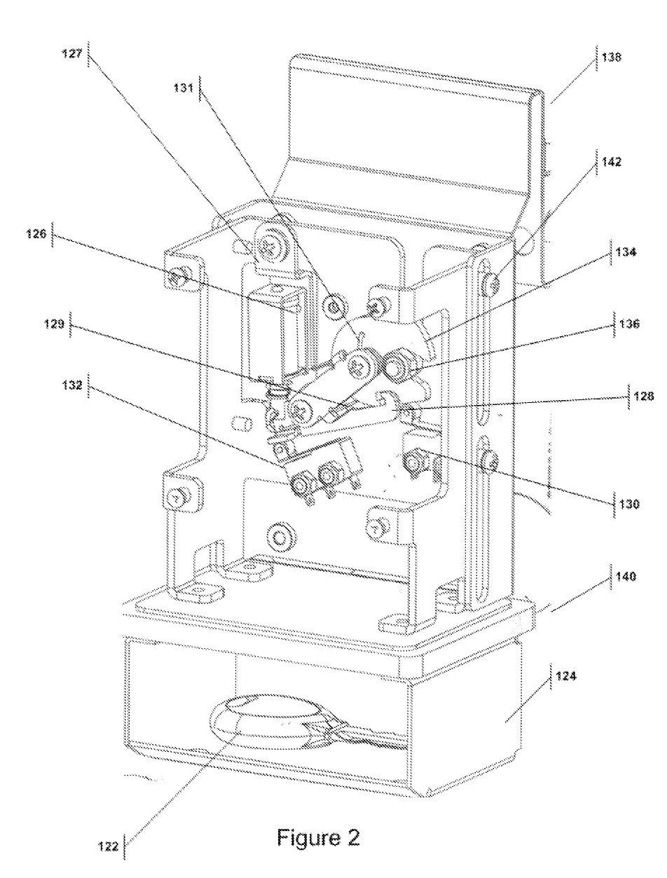

FIG. 2 is a detailed view of the inside of the lock box 100. This view shows the latch mechanism, key, key drawer, and hanging clip and illustrates the lock box being fabricated mostly of metal. Lock box 100 is hung on vehicle window using hanging clip 138. Vehicle key 122 is stored in lock box key drawer 124. Drawer gasket 140 seals against the housing of the lock box such that water cannot enter from the bottom of the lock box.

When key fob 104 is placed adjacent to lock box 100 and key fob access button 105 is pressed an inductive signal is transmitted from key fob inductive antenna 164 to key lock box controller inductive antenna 196. The key lock box controller 189 decodes this signal and verifies that the key fob has been authorized.

If the key fob was previously authorized, key lock box controller green LED 191 a is turned on. This LED signals to the person attempting to gain access to the lock box that the attempt was successful. If the key fob was not previously authorized, key lock box controller red LED 191b blinks rapidly to indicate that the attempt was not successful.

As always, in both these two situations the lock box controller 189 transmits these events using lock box controller radio transceiver 202 and lock box controller radio antenna 200 to sound and strobe light alarm unit 110 which in turn functions as a communication relay unit to relay this information to server database 112 for storage and later reporting.

Key lock box drawer 124 slides out of the bottom of the box using key lock box slides 142. By causing the drawer to slide out of the bottom no holes are required in the sides or top of the key lock box enclosure thereby preventing any water from entering the lock box.

Latch pin 136 is attached to key lock box housing. Latch 134 holds latch pin 136 in place thereby preventing lock box drawer 124 from sliding down. Latch hook 128 engages latch 134 thereby preventing latch from rotating and allowing latch pin 136 from disengaging. Latch hook 128 is held in place by latch hook torsion spring 129. Latch is held in place by latch torsion spring 131. Solenoid 126 is attached to latch hook 128. Latch hook 128 and latch 134 are interlocked in such a way to prevent banging on any surface from disengaging the latch hook 128 from the latch 134.

In normal operation solenoid 126 will move latch hook 128 out of holding position, thereby allowing latch 134 to rotate and allow latch pin 136 to slide out of position. In order to save power, solenoid 126 can be made less powerful and draw less current by relieving pressure of latch pin 136, latch 134, and latch hook 128. This relieving of pressure is accomplished by pressing upward on bottom of key lock box drawer 124.

Further, latch 134 and latch hook 128 anti-banging interlock feature is disengaged by pressing upward on the lock box.

Key lock box controller 189 senses upward pressure on bottom of key lock box 124 using key drawer push detect switch 130. When such said switch closes solenoid 126 is activated thereby moving latch hook 128 out of position. Because key lock box controller 189 can determine exactly when to actuate solenoid 126, battery power is saved by only actuating solenoid for a very short time.

Due to a well known phenomena regarding solenoids, the amount of current required to hold a solenoid in retracted position after that solenoid is retracted is significantly less than the current required to initially retract that solenoid. Let us refer to the initial current as strike and to the holding current as hold. Therefore, a significant savings in current can be achieved by only striking the solenoid for a short period, say 1 second and then continuing to apply hold current until lock box drawer is allowed to slide down.

When lock box drawer 124 slides down key lock box drawer open switch 132 closes thereby indicating to lock box controller 189 that the hold current may be removed. This method sequencing strike and hold current provides for a significantly less complicated opening sequence while still saving battery current.

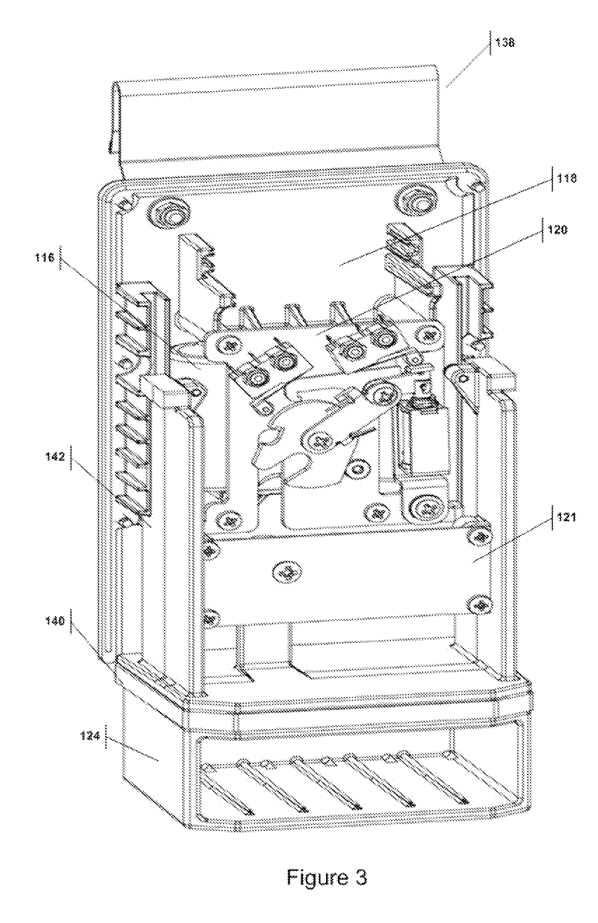

FIG. 3 is a detailed view of a lock box fabricated using plastic injected molding techniques. In this version many of the more expensive metal parts are replaced with features in the plastic housing. Battery 116 is captured by features in the plastic. Latch plate 120 is simplified by removing bends in the metal. Cavity 118 is included for future electronic capability such as GPS.

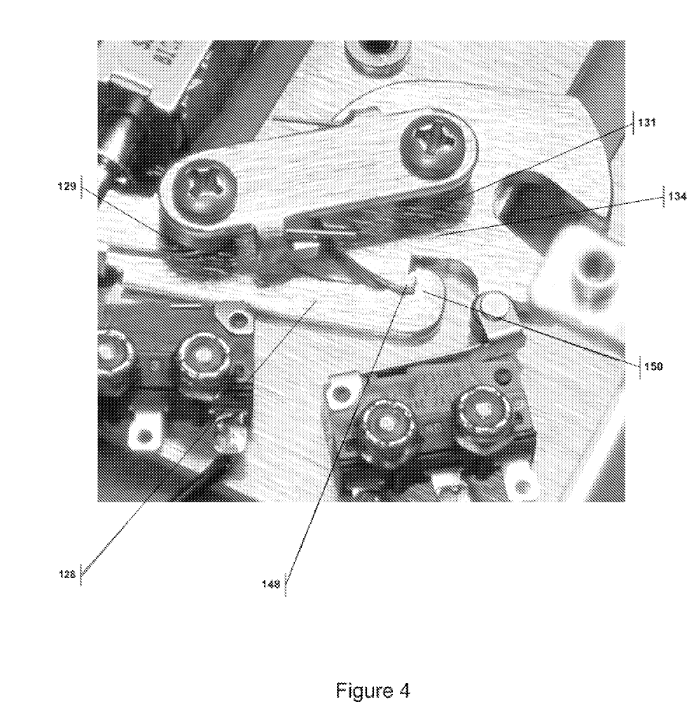

FIG. 4 shows a close up view of the key lock box latch mechanism. Latch hook 128 has a interlock socket feature 150. Latch 134 has a interlock pin feature 148. Pin 148 engages into socket feature 150 so as to prevent latch hook 128 from disengaging from latch 134 due to banging or dropping the lock box. The latch hook and latch interlocking pin and socket prevent the latch hook from disengaging unless the lock box drawer is pressed upward.

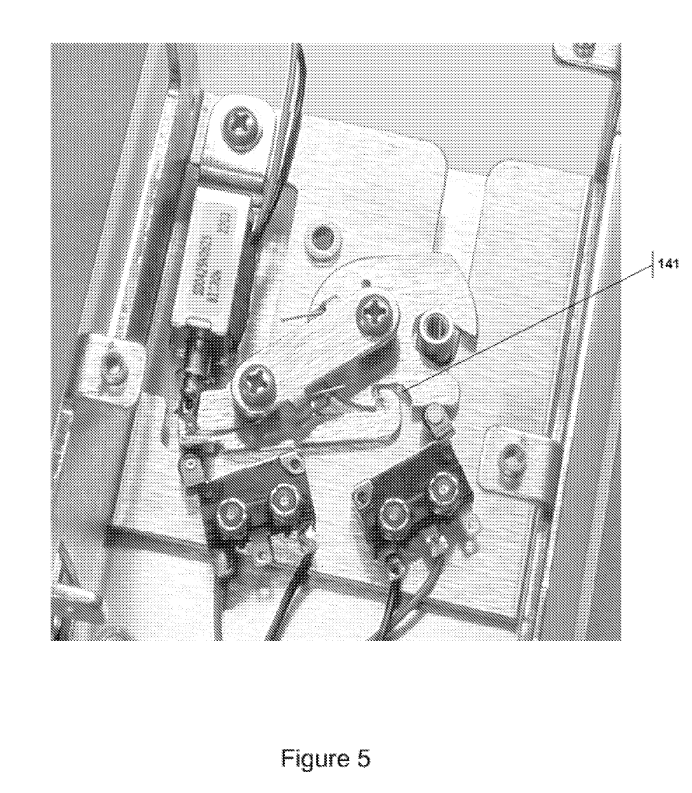

FIG. 5 shows a close up view of the key lock box latch and latch hook interlock 135 during a drawer press. The action of pressing the drawer upward causes the pin 148 to be removed from the socket 150.

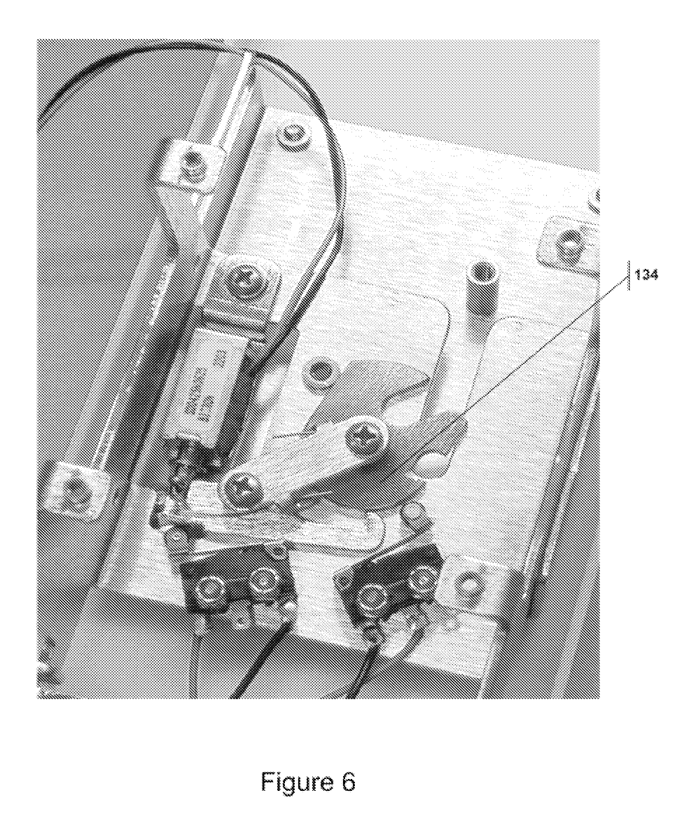

FIG. 6 shows a close up view of the key lock box latch 134 rotated out of position during a drawer open.

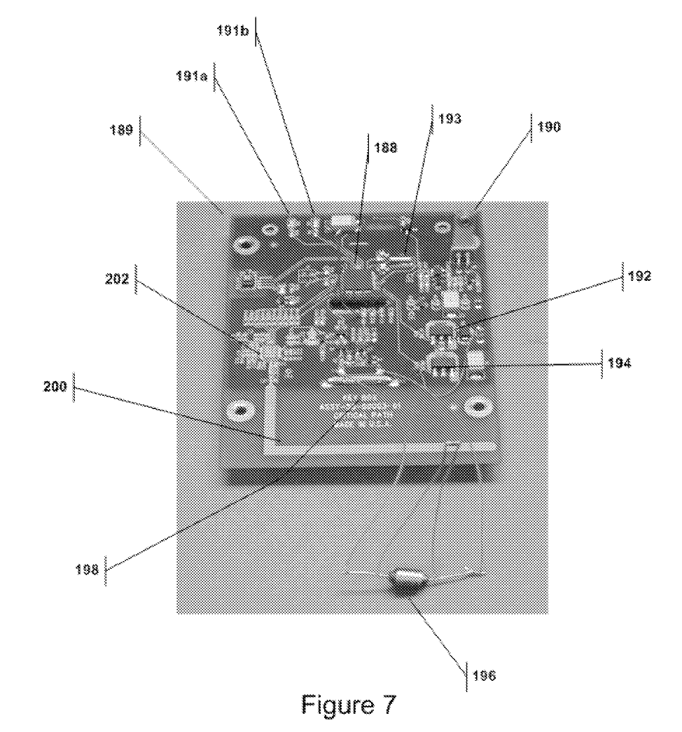

FIG. 7 shows the lock box controller printed circuit board 189. Microprocessor 188 is always powered but typically in a low power sleeping state. When the piezo motion sensor 190 senses tampering, the sensor sends a signal to the microprocessor, which wakes the microprocessor. The microprocessor then sends this information via radio 202 and radio antenna 200 to the sound and strobe light unit 110. LED's 191a and 191b are used to signal status such as key lock box access attempted accepted. Inductive antenna 196 is used to communicate with the key fob 104. Strike transistor 192 and hold transistor 194 allow for simplified operation of the key lock box solenoid while reducing power consumption.

The inductive communication between the key fob and the key lock box is an electromagnetic communication therefore not requiring any holes in the lock box chassis for connectors. Eliminating any such holes also eliminates any point for water to enter the lock box and potentially cause water damage.

The piezo film motion sensor is a passive device requiring no power, but capable of generating a voltage when moved. As a result this sensor technology can wake the processor from deep sleep without requiring power from the lock box battery.

Real time clock crystal 193 provides for very accurate time keeping by the key lock box microprocessor 188. This accurate real time clock provides a method for the lock box to turn on and off the motion sensor according to a preprogrammed schedule. This time schedule also provides a method of enabling and disabling reception of the key fob. By only turning on the motion sensor or inductive communication link when they are expected to be needed, both these methods lower power consumption.

Further, the accurate real time clock provides a method to greatly simply getting FCC approvals. The use of single carrier radio transmission in a deterministic periodic pattern is problematic. If a radio is polled or even chirps in a deterministic periodic pattern then the power levels of the transmitter must be reduced to get FCC approval. This invention provides a method of avoiding the problem by not polling and not chirping in a periodic pattern.

The real time clock provides a method of creating distinct time slots. A randomization technique is used to cause the lock box radio transmitter to randomly pick a time slot. If a pseudorandom generator is used then the polynomial must be sufficiently long enough that the transmission does not repeat over the life time of the product. The generator is initialized differently for each lock box, thereby forcing the lock boxes to not transmit at the same time.

Radio 202 of the key lock box controller and radio 217 of the sound and strobe light unit are frequency shift keyed at any of several channels. Each channel is separate and distinct and does not conflict with any other channel. Providing multiple channels allows for multiple dealerships to be located near each other without the interference or congestion which would be created by all facilities being on the same channel. Further, very large facilities can be subdivided into smaller zones using these channels thereby also reducing the same interference and congestion.

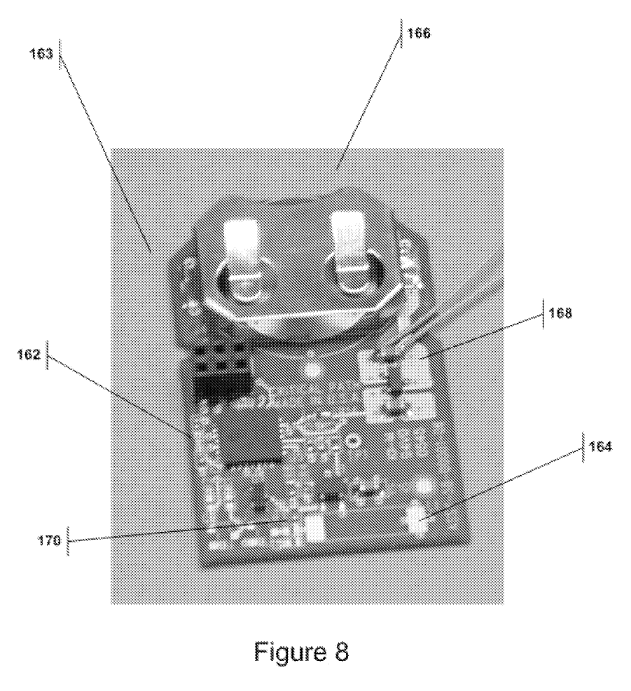

FIG. 8 is the key fob printed circuit board 163. Microprocessor 162 is powered by battery 166 via voltage regulator 168. Inductive antenna 164 is tuned with tuning capacitor 170 to a frequency of 127 kHz or 132 kHz. Microprocessor 162 is always powered but typically in a low power sleeping state. When key fob button 105 is pressed, a signal is sent to microprocessor which wakes the microprocessor. Microprocessor then sends a key lock box access attempt transmission via inductive antenna 164. If the key fob is adjacent to the lock box 100 then that message is received by the lock box. If the key fob is adjacent to the inductive key fob reader/writer 106 then that message is received by the reader/writer.

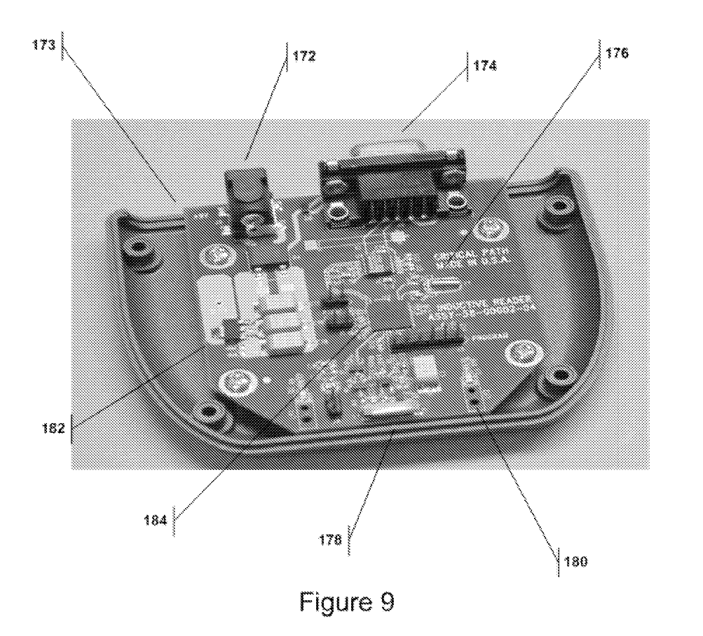

FIG. 9 is the inductive key fob reader/writer printed circuit board. Reader/writer is powered via connector 172. Reader/writer communicates with reader/writer controller 108 via RS232 connector 174. Voltage regulator 182 limits power from wall adapter to safe voltage for microprocessor 184. Real time clock crystal 176 provides accurate timing information to microprocessor 184. Inductive antenna 178 provides for communication with inductive key fob 104. LED 180 provides for indicating to users the state of progress when communicating with key fob 104.

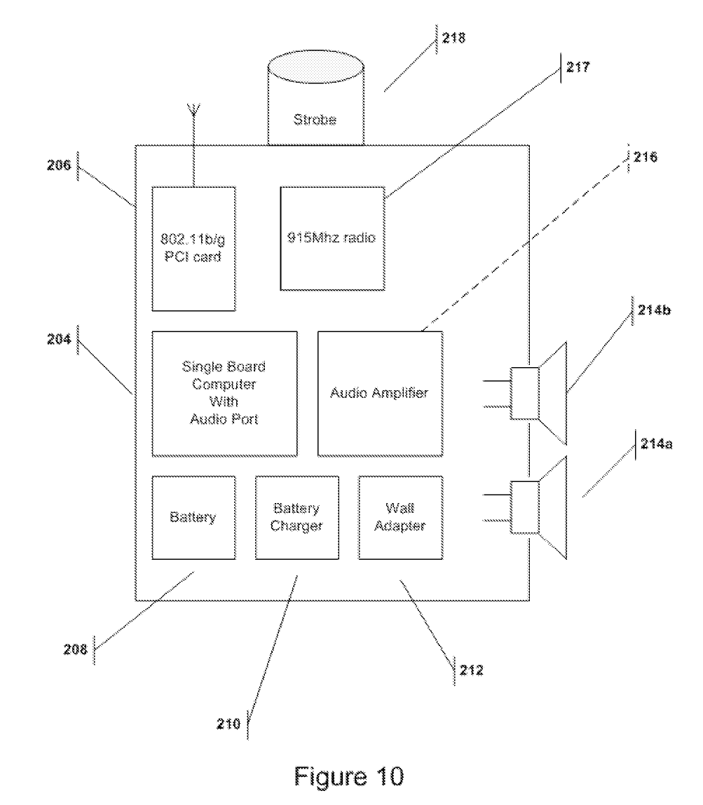

FIG. 10 is a block diagram of the sound and strobe light unit. Wall adapter 212 provides power to battery charger 210. Battery charger 210 charges battery 208. All components shown in FIG. 10 are powered by battery 208. Battery 208 functions as a backup during power outages, but also functions to power the unit at night.

Typically the sound and strobe light unit will be mounted to a light pole. The power to a light pole will always be on at night, but frequently off during the day time. The reason for this is that the lights and therefore the light pole power are centrally controlled by a timer. Battery 208 is sized such that the sound and strobe light unit can run during the day when the light pole power is off only being charged at night when the power is on. The significance of this feature is that when the sound and strobe light units are installed in a preexisting facility, the asphalt or other ground surface preparation does not need to be dug up to lay power cables in the ground. This is a significant sales feature in a facility such at a automotive dealership.

For the same reason this invention contemplates using 802.1 lb/g wireless Ethernet for communication between the sound and strobe light unit 110 and the database server 112.

Single board computer 204 is the controller for the sound and strobe light unit. Single board computer 204 receives messages from lock box 915 MHz radio 202 using a 915 MHz radio 217. These messages are relayed to server 112 using an 802.1 lb/g PCI card 206. Strobe 218 is turned on during unauthorized access attempts. Prerecorded messages are played by single board computer 204 into speakers 214a and 214b after being amplified by audio amplifier 216.

Operation:

An individual wishing to gain access to a key lock box places his key fob 104 adjacent to the inductive key fob reader/writer 106 and presses key fob button 105. Reader/writer sends message to controller 108 indicating an attempt to authorize the key fob. Controller 108 looks up key fob in data base 112 to determine whether this key fob is a valid key fob, issued to a valid individual, who should be on the facility at this time. Controller prompts individual for a password. Individual enters password. Controller validates password against password found in database 112. Controller then instructs read/writer 106 to write an authentication value into the memory of processor 162 of key fob 104. Controller sends message to database server 112 indicated that key fob was successfully authenticated. Database 112 logs all events for later report generation.

Individual then at some later time places key fob 104 adjacent to key lock box 100 and presses key fob button 105. Key fob transmits access message to key lock box. Key lock box 100 in turn relays this access request message to sound and strobe light unit 110 which in turn relays this message to server 112. Server 112 looks into database previously accessed by reader/writer controller 108 to verify that the individual has successfully logged into the system. Having verified that the individual is valid and that the key fob 104 is valid, the server 112 sends a message via the sound and strobe light unit 110 to the lock box 100 that the access is valid. Key lock box 100 flashes LED 191a indicating that access is granted. Individual presses drawer 124 upward. Lock box detects drawer push and strikes solenoid and holds solenoid. Individual allows lock box drawer to drop. Lock box detects drawer drop and releases solenoid.

Alternative Embodiments:

Alternatively, the inductive communication link between the key fob and the lock box may take on other forms, such as optical links including infrared, which achieve the object and advantages of this invention.

The 915 MHz radio communication link between the lock box and sound and strobe light unit might alternately be at some other frequency such as a 2.4 GHz Bluetooth radio communication link or 433 MHz.

The key fob button may alternatively be replaced with conductive carbon pills or even a capacitive switch.

The inductive key fob reader/writer controller communication link between the controller and the reader/writer may alternatively be changes from RS232 to USB.

The inductive key fob reader/writer printed circuit board may alternately be powered directly from the RS232 link or from the USB link.

The link between the sound and strobe light unit and the server may be alternatively implemented as hard wired RJ45 Ethernet, particularly where jamming of the 802.11 signals is considered a possibility.

Alternatively, the drawer push switch, being expensive, may be replaced by another technique for signaling the microprocessor that the solenoid should be energized. The key fob may have a second button labeled open.

Alternately, the lock box may have conductive electrodes on the bottom of the drawer which detect that the users hand has pushed the drawer up.

I claim:

1. A lock box system adapted for secure access to a stored key comprising:
one or more key devices;
one or more lock boxes in which a selected key device requests access to a selected lock box; and
a key fob controller that authorizes access to the selected lock box using the selected key device by communication between the key fob controller and the selected lock box.

2. A lock box system as in claim 1 including at least one relay unit intermediately situated in the system between the key fob controller and the lock boxes for relay of communication between the key fob controller and the lock boxes.

3. A lock box system as in claim 1 in which the key devices are key fobs.

4. A lock box system as in claim 1 including a server providing data to the key fob controller, wherein the key fob controller searches and controls the data for authentication of the selected key device.

5. A lock box system as in claim 3 including lock box controllers in the lock boxes that are in electronic communication with the key fob controller and that operate so that a selected key fob communicates discretely with the selected lock box via the lock box controller to request access to the selected lock box.

6. A lock box system as in claim 3 in which the key fobs are validated by the key fob controller prior to the selected key fob requesting access to the selected lock box.

7. A lock box system as in claim 6 including at least one key fob reader and writer device that electronically communicates with the selected key fob and the key fob controller concerning validation of the selected key fob.

8. A lock box system as in claim 1 in which the lock boxes each include a lock box latch mechanism for securing a drawer and releasing the drawer of a selected lock box for access upon validation of the selected key device.

9. A lock box system as in claim 5 in which the lock box controllers each include a microprocessor that remains in a low power state until the access request is made by the selected key fob or until an unauthorized access request or tampering with the selected lock box occurs.

10. A lock box system as in claim 9 in which the lock box controllers each include a real time clock crystal, and the lock box controllers are pre-programmable for enabling and disabling reception the key fobs, and the lock box controllers are pre-programmable for pseudorandom transmission from the lock box controllers to the key fob controller to prevent conflicting communication between multiple lock boxes and the key fob controller.

11. A lock box system as in claim 5 in which the lock box controllers each include a piezo or accelerometer based motion sensor.

12. A lock box system as in claim 5 including at least one relay unit intermediately situated in the system between the key fob controller and the lock box controllers for relay of communication between the key fob controller and the lock box controllers.

13. A lock box system as in claim 12 in which the lock box controller of the selected lock box communicates the access request by the selected key fob to the relay unit, the relay unit communicates the access request to the key fob controller, the key fob controller verifies the validity of the selected key fob for access to the selected lock box, the key fob controller communicates the validity of the selected key fob to the relay unit, and the relay unit communicates the validity of the selected key fob to the lock box controller of the selected lock box.

14. A lock box system as in claim 13 including a server providing data to the key fob controller, wherein the key fob controller searches and controls the data for authentication of the selected key fob, the server logs information concerning validation of the key fobs and activity by the lock box controllers, and the server provides authorizations to both the lock box controllers and the key fobs at different levels that may include a master level in which the selected key fobs always work, a daily level in which the selected key fobs work on a programmable schedule or another programmable level with predetermined authorizations and limitations with regard accessibility of the lock boxes.

15. A lock box system as in claim 12 in which the lock box controller communicates an unauthorized access attempt or tampering to the relay unit, and the relay unit transmits notice of the unauthorized access attempt by electronic communication to a server or a monitoring system, by a visual device, or by a sound device.

16. A lock box system as in claim 5 in which the selected key fob communicates discretely with the selected lock box via the lock box controller by inductive, magnetic or optical communication.

17. A lock box system as in claim 5 in which the key fobs and the lock box controllers include inductive antennas.

18. A lock box system as in claim 1 in which the key fob controller and the lock boxes each include a radio transceiver device and communicate by a radio frequency communication path between the key fob controller and the lock boxes.

19. A lock box system as in claim 2 in which the relay unit comprises a microprocessor controlled transmitter and receiver, a warning system, and a power system with rechargeable battery that is connected to a power source for recharging of the battery.

20. A lock box system as in claim 19 in which the power source is a light pole providing part-time power to the rechargeable battery for recharging during nighttime hours.

21. A method for secure access to a stored key comprising the steps of:
communicating authentication data from a server to one or more lock boxes;
providing a registration controller;
individually registering one or more key devices on the server using the registration controller;
communicating registration of the individual key devices to the lock boxes;
requesting access to a particular lock box using a particular key device;
determining validity of the access request by the key device; and
granting or denying access by the key device to the lock box.

22. A method for secure access to a stored key as in claim 21 in which the steps of communicating registration of the individual key device to the lock box includes the steps of communicating authentication data to the key device using the registration controller and directly communicating the authentication data on the key device from the key device to the lock box.

23. A method for secure access to a stored key as in claim 21 in which after the step of requesting access to the particular lock box includes the steps of:
communicating the access request from the lock box to the registration controller or server; and
communicating validity of the key device to lock box after a determination is made by the registration controller as to validity following the access request.

24. A method for secure access to a stored key as in claim 23 in which the lock box and the registration controller communicate over a radio frequency concerning the validity of the particular key device.

25. A method for secure access to a stored key as in claim 24 in which communication between the lock box and the registration controller is relayed by an intermediary annunciator.

26. A method for secure access to a stored key as in claim 21 in which the step of requesting access to a particular lock box using a particular key device includes inductive communication between the key device and the lock box.
